(19) United States
(12) Patent Application Publication
(10) Pub. No.: US 2008/0289723 A1
(43) Pub. Date: Nov. 27, 2008

(54) Rough hew planer

(76) Inventor: Martin Janzen, Horsefly (CA)

Correspondence Address: Antony C. Edwards, P.O. Box 26020, Westbank, BC, V4T 2G3, CA

(21) Appl. No.: 11/802,465

(22) Filed: May 23, 2007

(51) Int. Cl. B27C 5/10; B27G 13/12; B27G 17/02

(52) U.S. Cl. 144/137; 30/484

(57) ABSTRACT

Disclosed is a method and apparatus finishing the surface of a wood piece to appear rough hewn. The apparatus comprises a hand planer having a longitudinal direction, a rotatable cutter head having at least one planning blade and a bottom surface. The bottom surface has a convex curved profile longitudinally along the hand planer. The cutter head extends below the curved profile of the bottom surface. The method comprises simultaneously translating and rocking the hand planer on the bottom surface so as to intermittently engage the cutter head against a surface so as to form a plurality of spaced apart divots therein.

### FIELD OF THE INVENTION

This invention relates to the field of devices and methods for finishing of logs in general and in particular to a method and apparatus for surface finishing a log to appear rough hewn.

### BACKGROUND OF THE INVENTION

Log homes are well known and have remained popular over the years. The use of logs for constructing homes and other buildings requires that the bark and branches be removed. Advances in log processing has allowed raw logs to be processed more quickly than previously and with less man power than by using previous hand processing methods. Many of these now conventional techniques, such as milling, for example, not only remove the bark and branches but also render the resulting log substantially uniform in shape. While more efficient, such techniques also are less desirable to some purchasers who prefer the look of logs prepared using traditional methods such as hewing or utilizing an adz which results in a plurality of random hew or adz marks distributed across and along the log.

Previous attempts to preserve the look of a rough hewn log have not been satisfactory. For example, U.S. Pat. No. 3,957,095 issued May 18, 1976 to Johnson discloses a rough hewn bench plane attachment comprising an eccentric roller attachment under one end of a hand plane such that the plane is caused to move in an eccentric manner with respect to the work piece so that a cutting iron gouges the work piece. Such an attachment will produce regularly spaced apart marks which do not accurately replicate the desired random appearance of hew marks.

In addition, U.S. Pat. Nos. 4,949,768 issued Aug. 21, 1990 to Giles et al., 3,756,295 issued Sep. 4, 1973 to Halop, 3,495,638 issued Feb. 17, 1970 to Humphrey, 3,703,198 to Lubes et al. and 3,353,574 issued Nov. 21, 1967 to Kvalheim et al. all disclose machines which impart a plurality of hew marks to a work piece fed through the machine wherein the marks are then cut by at least one rotary member within the machine. Again, the hew marks resulting from these machines will be regularly spaced apart as well as having a regular depth and length. Work pieces resulting from these devices will not therefore have a satisfactory hand hewn appearance.

What is desirable is an apparatus and method for surface treating a work piece of wood to appear rough or hand finished with a hew wherein the hew marks or divots are irregular in spacing and appearance. Such a method and apparatus would also be desirably useful for surface treating lots as well as board, timbers and other types of wood products as well.

### SUMMARY OF THE INVENTION

What is disclosed is a method and apparatus for finishing the surface of a wood piece so as to appear rough or hand hewn.

According to a first embodiment of the present invention there is disclosed a hand planer for finishing the surface of a wood piece to appear rough hewn. The hand planer has a longitudinal axis and, in use, is translated in a longitudinal direction along the longitudinal axis. The planer has a bottom surface which has a convexly curved profile longitudinally along the hand planer. A rotatable cutter head having at least one planning blade extends below the curved profile of the bottom surface. Rocking the planer on the bottom surface while simultaneously translating the planer along a logs smoothly finished surface intermittently engages the cutter head against the surface of the log so as to form a plurality of spaced apart scalloped excavations in the log.

The cutter head is advantageously aligned transverse to the longitudinal axis of the hand planer. The planing blade or each planing blade if more than one may have a curved profile in a direction transverse to the longitudinal axis of the hand planer. The bottom surface may comprise a forward bottom surface ahead of the cutter head in a direction of travel of the hand planer and a rear bottom surface behind the cutter head in a direction of travel of the hand planer. The bottom surface may include a planar portion proximate to the cutter head. The hand planer may comprise at least one removable shoe mountable having the bottom surface to the hand planer.

According to a further embodiment of the present invention there is disclosed a kit for adapting a planer for finishing the surface of a wood piece to appear rough hewn. The kit comprises a rotatable cutter head rotatably receivable within the hand planer, and a bottom shoe securable to a bottom of said hand planer. The bottom shoe has a length and a bottom surface having a convex curved profile longitudinally along the shoe and a transverse opening in the bottom surface through which the cutter head may be protruded.

At least one planning blade may have a curved profile in a direction transverse to the length of the hand planer.

The bottom shoe may comprise a front shoe having a front surface locatable ahead of the cutter head in a direction of travel of the hand planer and a rear shoe having a rear surface locatable behind the cutter head in a direction of travel of the hand planer. The rear surface may include a planar portion located proximate to the cutter head when the rear shoe may be secured to the hand planer.

According to a further embodiment of the present invention there is disclosed a method of finishing the surface of a wood piece to appear rough hewn. The method comprises providing a hand planer having a rotatable cutter head having at least one planning blade and a convex curved bottom surface. The cutter head extends below the bottom surface. The method further comprises simultaneously translating and rocking the hand planar on the bottom surface so as to intermittently engage the cutter head against the surface of the wood piece so as to form a plurality of spaced apart divots therein.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a side view of a hand planner according to a first embodiment of the present invention.

FIG. 2 is a bottom view of the hand planer of FIG. 1.

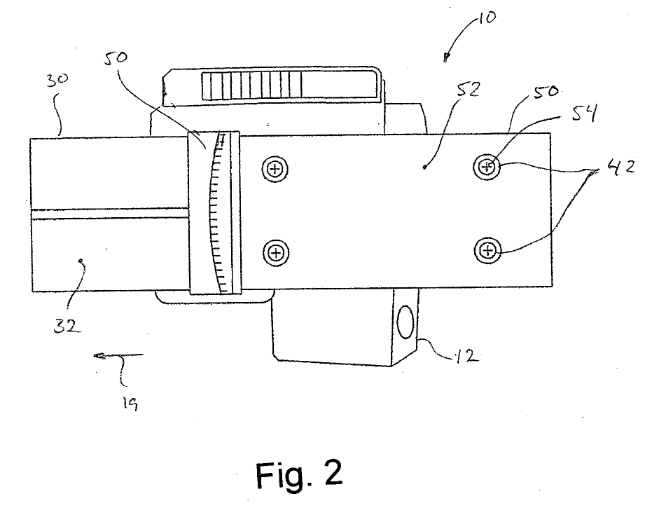

FIG. 3 is an exploded perspective view of the hand planer of FIG. 1.

FIG. 4 is a perspective view of the chipping rotor of FIG. 1.

FIG. 5 is a side view of the hand planer of FIG. 1 at a plurality of positions in operation on a board.

FIG. 6 is a perspective view of a surface finished by the hand planer of FIG. 1.

FIG. 7 is a perspective view of front and rear bottom shoes according to an alternative embodiment of the present invention.

### DETAILED DESCRIPTION OF EMBODIMENTS OF THE INVENTION

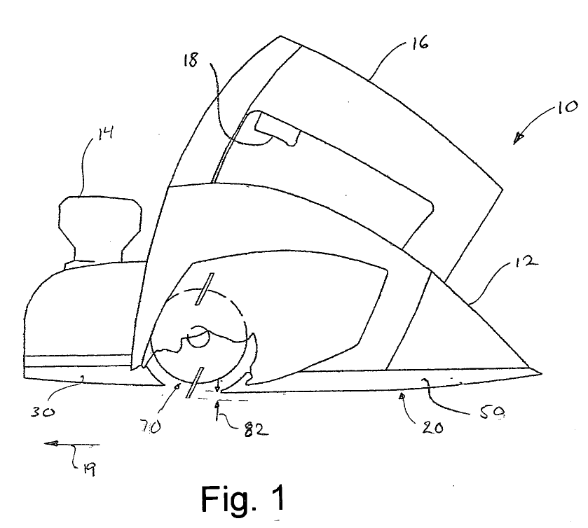

Referring to FIG. 1, an apparatus according to a first embodiment of the invention is shown generally at 10. The apparatus comprises a hand planer 12 having a curved bottom 20 and a rotatable transverse cutter rotor 70 therein. The hand planer 12 is of a conventional type and includes an electric motor (not shown) and first and second handles 14 and 16, respectively. The second handle includes a power button or trigger 18 for energizing the motor so as to rotate the cutter rotor 70. The hand planer 12 is translatable in a forward direction indicated generally at 19 so as to finish the surface of a wood workpiece.

The hand planer 12 includes a front bottom shoe 30 and a rear bottom shoe 50 attached to the bottom thereof. The front and rear bottom shoes 30 and 50 may be formed integrally with the hand planer 12 or may optionally be securable to the bottom of the hand planer 12 by means of screws 54 or other suitable fasteners as are known in the art. It will be appreciated that other methods of fastening the front and rear bottom shoes 30 and 50 may also be utilized. The bottom shoe 30 is located forward of the cutter rotor 70 in the direction of travel 19 of the hand planer and includes a forward bottom surface 32. The rear bottom shoe 50 is located behind the cutter rotor 70 in the direction of travel 19 of the hand planer 12 and includes rear bottom surface 52.

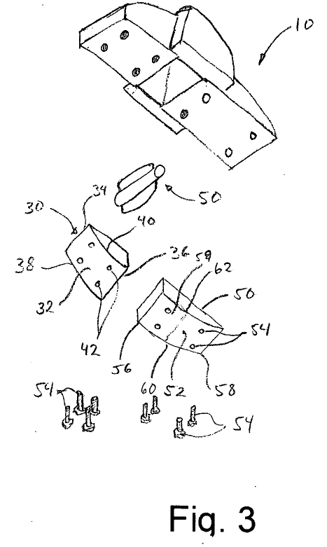

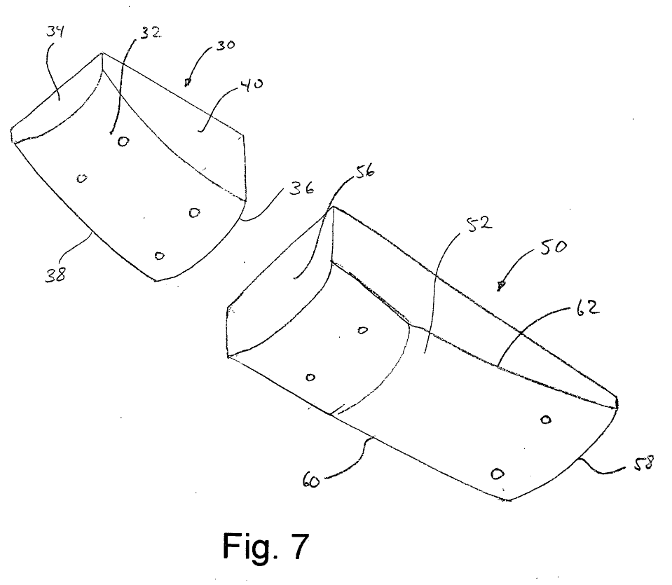

Turning to FIG. 3, the front bottom shoe 30 comprises a substantially rectangular body having leading and trailing edges 34 and 36, respectively and first and second side edges 38 and 40, respectively. Forward bottom surface 32 is disposed between the leading and trailing edge 34 and 36 and may include a plurality of bores 42 for passing screws 54 therethrough so as to secure the forward bottom shoe 30 to the hand planer 12. As illustrated, forward bottom surface 32 is convexly curved between the leading and trailing edges 34 and 36 of the front bottom shoe. The forward bottom surface 32 may be curved at a constant curve or may have a curvature that is greater proximate to the leading or trailing edge 34 or 36. In an alternative embodiment, the forward bottom surface 32 may also be convexly curved between the first and second side edges 38 and 40 as illustrated in FIG. 7. By way of not-limiting example, the curvature of the bottom surface 20 may be such that the difference in the thickness between the leading and trailing edges 34 and 36 of the front bottom shoe 30 is between ⅛ and 3/16 of an inch wherein the forward bottom surface is substantially horizontal proximate to the trailing edge although it will be appreciated that other curvatures will be useful as well.

The rear bottom shoe 50 comprises a substantially rectangular body having leading and trailing edges 56 and 58, respectively and first and second side edges 60 and 62, respectively. Rear bottom surface 52 is disposed between the leading and trailing edge 56 and 58 and may include a plurality of bores 42 for passing screws 54 therethrough so as to secure the rear bottom shoe 50 to the hand planer 12. As illustrated rear bottom surface 52 is convexly curved between the leading and trailing edges 56 and 58 of the rear bottom shoe. The rear bottom surface 52 may be curved at a constant curve or may have a curvature that is greater proximate to the leading or trailing edge 56 or 58. Optionally, the rear bottom surface 52 may include a planar portion 59 proximate to the leading trailing edge 56. In an alternative embodiment, the rear bottom surface 52 may also be convexly curved between the first and second side edges 60 and 62 as illustrated in FIG. 7. By way of non-limiting example, the curvature of the bottom surface 20 may be such that the difference in the thickness between the leading and trailing edges 58 and 58 of the front bottom shoe 50 is between ⅛ and 3/16 of an inch wherein the rear bottom surface is substantially horizontal proximate to the trailing edge although it will be appreciated that other curvatures will be useful as well.

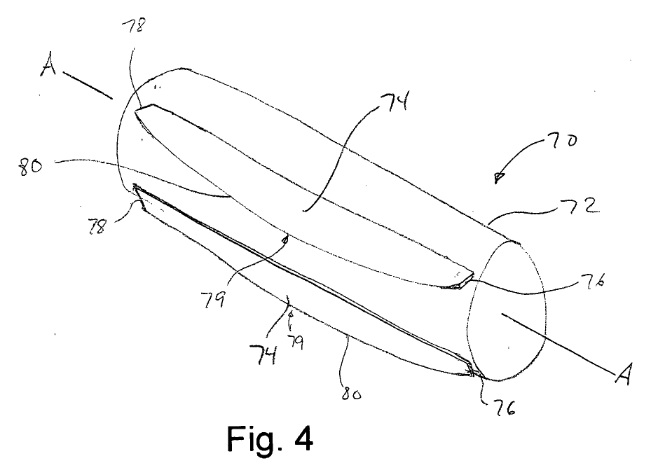

Turning now to FIG. 4, a perspective view of the cutter rotor 70 is shown. The cutter may be of a conventional type as are know in the art having a substantially cylindrical rotor body 72 and a plurality of cutter blades 74 extending therefrom. The cutter blades 74 extend substantially radially from the rotor body 72 although it will be appreciated that other orientations of the cutter blades relative to the rotor body will also be useful such as at an angle angularly offset from an angle extending exactly radially from the axis A of rotor body 72. The cutter blades 74 comprise an elongate planar member having first and second ends 76 and 78, respectively, and a cutting edge 80 extending therebetween. The cutting edge 80 as illustrated in FIG. 4 may be convex between the first and second ends 76 and 78. The curvature of the cutter edge 80 may be constant between the first and second ends 76 and 78 although it will be appreciated that variable curvature edges may also be useful. By way of non-limiting example, the curvature of the cutting edge 80 may be such that the edge has a height difference between the ends 76 and 78 and the center portion 79 of between ⅛ and 3/16 of an inch although it will be appreciated that other curvatures will be useful as well.

Referring back to FIG. 1, when installed in a hand planer 12, the cutting edges 80 of the cutter rotor 70 protrudes from the hand planer 12 past the front and rear bottom surfaces 32 and 52, by a distance generally indicated at 82. By way of non-limiting example, the cutting edges 80 of the cutter rotor 70 may protrude from the front and rear bottom surfaces by a distance of between 1/16 and 3/16 of an inch although it will be appreciated that other distances may be useful as well.

### Operation

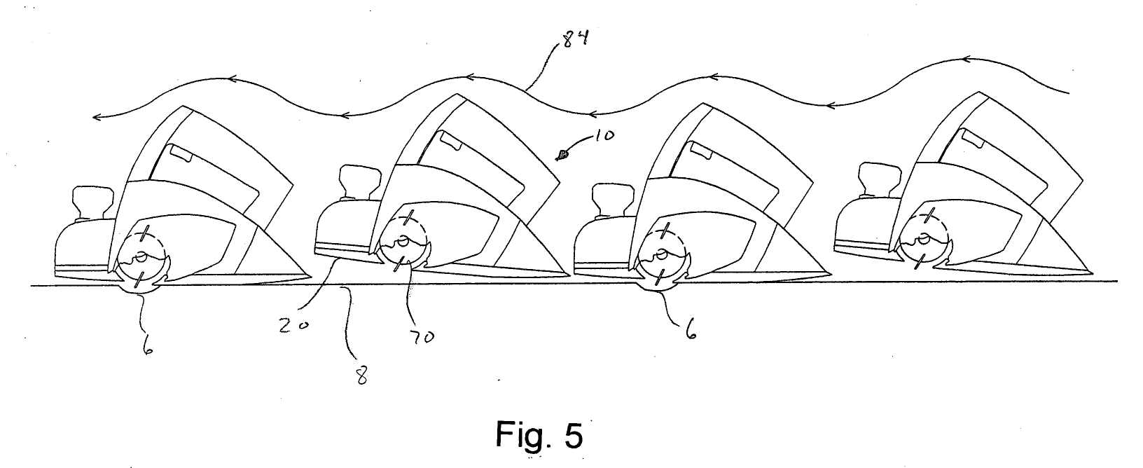

In operation a user grasps the hand planer 12 having a curved bottom surface 20 and protruding cutter rotor 70 as described above. With the power button 18 depressed so as to rotate the cutter rotor 70, the user may place the bottom surface 20 against a wood surface to be finished. The user may then simultaneously translate the planer in a foreword direction 19 while rocking the planer in a vertical plane containing the direction of travel 19 along the curved bottom surface 20, for example in the sequence illustrated in FIG. 5. The hand planer will therefore be moved along the surface 8 of the workpiece 7 along a cyclical for example sinusoidal path indicated generally at 84. As the planer is moved past a middle portion of the rocking motion, that is as the planer is rocked between being tipped forward and tilted backward in the vertical plane, the cutter rotor 70 is selectively brought into contact with the surface 8 thereby cutting scallops, divots or otherwise concave excavations 6 into the workpiece surface. The excavation thus formed, and especially if repeated in a random pattern over the workpiece surface, cause the surface to appear rough hewn. Thus, although the sequential motion is shown as a regular sinusoid, the rough hewn effect is better accomplished by a random cycling of the rocking motion while translating.

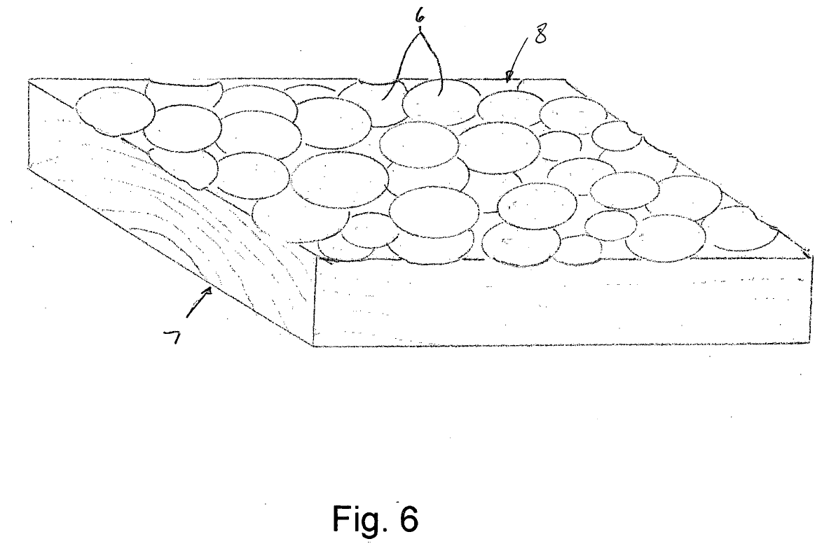

Thus, workpiece 7 may be finished by the use of planer 12 so that, as illustrated in FIG. 6, the workpiece has a plurality of randomly located divots 6 in the outer surface. It will be appreciated that by varying the translational speed of the planer relative to the rocking rate, divots of varying length and spacing may be formed. In addition, it will be appreciated that by performing only a partial rocking motion the cutter head may caused to form shallower divots in the surface.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A hand planer for finishing the surface of a wood piece to appear rough hewn, said hand planer having a longitudinal direction a bottom surface and a rotatable cutter head having at least one planing blade, said bottom surface having a convex curved profile longitudinally along said hand planer, said cutter head extending below said curved profile of said bottom surface, wherein rocking said head planer on said bottom surface while simultaneously translating said hand planer along a wood piece intermittently engages said cutter head against the surface of said wood piece so as to form a plurality of spaced apart excavations in said wood piece.

2. The hand planer of claim 1 wherein said cutter head is transverse to said longitudinal direction of said hand planer.

3. The hand planer of claim 1 wherein said at least one planning blade has a curved profile in a direction transverse to the length of said hand planer.

4. The hand planer of claim 1 wherein said bottom surface comprises a forward bottom surface ahead of said cutter head in a direction of travel of said hand planer and a rear bottom surface behind said cutter head in a direction of travel of said hand planer.

5. The hand planer of claim 4 wherein said rear bottom surface includes a planar portion proximate to said cutter head.

6. The hand planer of claim 1 further comprising at least one removable shoe mountable to said planer, said at least one shoe having said bottom surface.

7. A kit for adapting a hand planer for finishing the surface of a wood piece to appear rough hewn, the kit comprising:
a bottom shoe securable to a bottom of said hand planer, said bottom shoe having a length and a bottom surface having a convex curved profile longitudinally along said shoe and a transverse opening; and a rotatable cutter head rotatably receivable within the hand planer wherein said cutter head extends below said curves profile of said bottom surface when said cutter head and said bottom shoe are secured to the hand planer.

8. The planer of claim 1 wherein said at least one planing blade has a curved profile in a direction transverse to the length of said planer.

9. The kit of claim 7 wherein said bottom shoe comprises a front shoe having a front surface locatable ahead of said cutter head in a direction of travel of said planer and a rear shoe having a rear surface locatable behind said cutter head in a direction of travel of said planer.

10. The kit of claim 8 wherein said rear surface includes a planar portion located proximate to said cutter head when said rear shoe is secured to the hand planer.

11. A method of finishing the surface of a wood piece to appear rough hewn, the method comprising:
providing a hand planer having a rotatable cutter head having at least one cutting blade and a convex curved bottom surface, said cutter head extending below said bottom surface; and
simultaneously translating and rocking said hand planar on said bottom surface so as to intermittently engage said cutter head against the surface of the wood piece so as to form a plurality of spaced apart divots therein.
